(19) United States
(12) Patent Application Publication
(10) Pub. No.: US 2024/0263109 A1
(43) Pub. Date: Aug. 8, 2024

(54) APPARATUS AND METHOD FOR PRODUCING FERMENTED LIQUOR

(71) Applicant: SAMSUNG ELECTRONICS CO., LTD., Suwon-si (KR)

(72) Inventors: Myunggeun SHIM, Suwon-si (KR); Kwansuk YOO, Suwon-si (KR)

(73) Assignee: SAMSUNG ELECTRONICS CO., LTD., Suwon-si (KR)

(21) Appl. No.: 18/634,323

(22) Filed: Apr. 12, 2024

Related U.S. Application Data
(63) Continuation of application No. PCT/KR2022/015312, filed on Oct. 11, 2022.

(30) Foreign Application Priority Data
Oct. 13, 2021 (KR) 10-2021-0135536

(51) Int. Cl. C12C 13/10; C12G 3/02

(52) U.S. Cl. CPC C12C 13/10; C12G 3/02

(57) ABSTRACT

A device for producing fermented liquor includes: a main body, including: a control board; a carbon dioxide container connection; and a container, including: an outer container; a container cap, wherein the device is configured to: close a gas discharge port based on a pressure in the container reaching a first pressure; measure a first time for the pressure to become a second pressure, and store the first time; open the gas discharge port; close the gas discharge port based on the pressure becoming the first pressure, and measure a second time for the pressure to become the second pressure; and repeatedly, based on the second time being smaller than the first time: open the gas discharge port; close the gas discharge port based on the pressure becoming the first pressure; and measure the second time for the pressure to become the second pressure.

### CROSS-REFERENCE TO RELATED APPLICATION(S)

This application is a by-pass continuation application of International Application No. PCT/KR2022/015312, filed on Oct. 11, 2022, which is based on and claims priority to Korean Patent Application No. 10-2021-0135536, filed on Oct. 13, 2021, in the Korean Intellectual Property Office, the disclosures of which are incorporated by reference herein in their entireties.

### BACKGROUND

### 1. Field

This relates to a device and method for producing a fermented liquor and, more specifically, to a device and method for producing fermented liquor by identifying the yeast activity during the fermentation process depending on the type of fermented liquor.

### 2. Description of Related Art

Fermented liquor is a type of alcohol made by saccharifying and fermenting grains as raw materials, such as Takju, Yakju, Cheongju, beer, and Shaoxing wine or by fermenting sugary fruits, such as grapes and apples.

The alcohol content of fermented liquor is low, about 1% to about 18%, and contains several components related to volatile aromas generated during the sugar fermentation process, so it may have excellent taste and flavor compared to other types of alcohol.

Fructose is fermented through yeast to generate ethyl alcohol, carbon dioxide, and water, or starch is saccharified through starch diastase and fermented through yeast to produce sugar, ethyl alcohol, carbon dioxide, and water, thereby producing fermented liquor.

Consumers may purchase ready-made products manufactured and sold by a manufacturing company, or produce craft beer on their own by fermenting beer ingredients. Craft beer may be manufactured in more various types than ready-made beer, and may be manufactured according to the consumer's taste.

In general, craft beer produced directly by consumers may be produced by fermenting ingredients sold by the manufacturer. Craft beer may be produced through a fermentation process, stabilization process, aging process, and retention process.

During the process of producing craft beer directly produced by consumers, the flavor and taste of craft beer may vary depending on the fermentation process. Consumers may input craft beer recipes into the production device, but due to uncontrollable environmental factors, the activity of yeast may vary, and target flavor and taste may not be realized.

Therefore, there is provided a device and method for producing fermented liquor that may implement flavor and taste by identifying the activity of yeast in response to various environmental factors in the fermented liquor producing process.

### SUMMARY

A device for producing fermented liquor according to one or more embodiments includes: a main body, including: a control board, including a memory storing at least one instruction; at least one processor; a storage; a thermostat; and a communication interface; and a carbon dioxide container connection; and a container, including: an outer container, including: a fermented liquor discharge valve; a fermented liquor discharge port; a foreign body discharge valve; and a foreign body discharge port; and a container cap configured to seal the container, including: a gas discharge port, a gas supply port, a pressure gauge hole, a pressure gauge, and a thermometer, wherein the at least one processor may be configured to execute the at least one instruction to cause the device to: close the gas discharge port based on a pressure in the container reaching a first pressure, measure a first time for the pressure in the container measured through the pressure gauge to become a second pressure, and store the first time in the storage; open the gas discharge port; close the gas discharge port based on the pressure measured through the pressure gauge becoming the first pressure; measure a second time for the pressure in the container measured through the pressure gauge to become the second pressure; repeatedly, based on the second time being larger than the first time: open the gas discharge port; close the gas discharge port based on the pressure measured through the pressure gauge becoming the first pressure; and measure the second time for the pressure in the container measured through the pressure gauge to become the second pressure.

The container may further include an inner container, and the inner container may be disposed inside the outer container.

A container insulator may be disposed between the outer container and the inner container.

The container cap may further include a container cap sealing material, and the container may further include a container sealing material.

The main body may further include a status display.

The status display may be further configured to receive an input.

The at least one processor may be further configured to execute the at least one instruction based on a signal received through the communication interface.

The at least one processor may be further configured to execute the at least one instruction to cause the device to perform at least one of stabilization, refrigerated aging, or retention, based on the signal received through the communication interface.

The at least one processor may be further configured to execute the at least one instruction to control the thermostat such that a temperature in the container may be maintained as a designated temperature.

The at least one processor may be further configured to execute the at least one instruction to cause the device to inject carbon dioxide from the carbon dioxide container connection into the container through the gas supply port.

According to one or more embodiments, a method for producing fermented liquor using a fermented liquor producing device, including: a main body, including: a control board, including: a memory storing at least one instruction, at least one processor, a storage, a thermostat, and a communication interface, and including a carbon dioxide container connection, a container, including: an outer container, including: a fermented liquor discharge valve, a fermented liquor discharge port, a foreign body discharge valve, and a foreign body discharge port, and a container cap for sealing the container, and including: a gas discharge port, a gas supply port, a pressure gauge hole, a pressure gauge, and a thermometer, and may include: closing the gas discharge port based on a pressure in the container reaching a first pressure; measuring a first time for the pressure in the container part measured through the pressure gauge to become a second pressure, and store the first time; opening the gas discharge port; closing the gas discharge port based on the pressure measured through the pressure gauge becoming the first pressure; measuring a second time for the pressure in the container part measured through the pressure gauge to become the second pressure; and repeatedly performing based on the second time being smaller than the first time: the opening the gas discharge port; the closing the gas discharge port based on the pressure measured through the pressure gauge becoming the first pressure; and the measuring the second time for the pressure in the container measured through the pressure gauge to become the second pressure.

The container may further include an inner container, and the inner container may be disposed inside the outer container.

A container insulator may be disposed between the outer container and the inner container.

The container cap may further include a container cap sealing material, and the container may further include a container sealing material.

The main body may further include a status display.

By using a fermented liquor producing device and fermented liquor manufacturing method according to one or more embodiments, the activity of yeast may be indirectly identified.

By indirectly identifying the activity of yeast, the time when the activity of the yeast is highest and the time immediately before the activity of the yeast decreases may be identified, and a different process may be performed at a corresponding time. By identifying the activity of yeast to perform a different process, a target taste, carbonation level, and alcohol concentration of fermented liquor may be implemented.

### BRIEF DESCRIPTION OF THE DRAWINGS

FIG. 1 illustrates a fermented liquor producing device according to one or more embodiments;

FIG. 2 illustrates a fermented liquor producing method of a fermented liquor producing device according to one or more embodiments;

FIG. 3 illustrates a fermented liquor producing process according to one or more embodiments;

FIG. 4 illustrates a fermentation control process of a fermented liquor producing device according to one or more embodiments;

FIG. 5 illustrates the gravity of fermented liquor produced according to a fermentation period according to one or more embodiments; and

FIG. 6 illustrates a control screen controlling a fermented liquor producing device according to one or more embodiments.

### DETAILED DESCRIPTION

It should be appreciated that one or more embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

According to one or more embodiments, a method according to one or more embodiments may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. Some of the plurality of entities may be separately disposed in different components. According to one or more embodiments, one or more of the above-described components may be omitted, or one or more other components may be added. Alternatively or additionally, a plurality of components (e.g., modules or programs) may be integrated into a single component. According to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

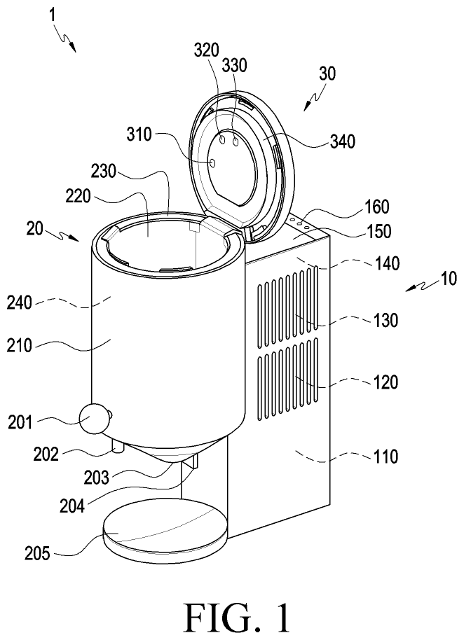

FIG. 1 illustrates a fermented liquor producing device according to one or more embodiments.

According to one or more embodiments, the producing device 1 may include a main body part 10, a container part 20, and a container cap 30.

According to one or more embodiments, the main body part 10 may include a control board 110, a thermostat 120, a communication interface 130, a carbon dioxide container connecting part 140, a main body cap 150, and a status display unit 160.

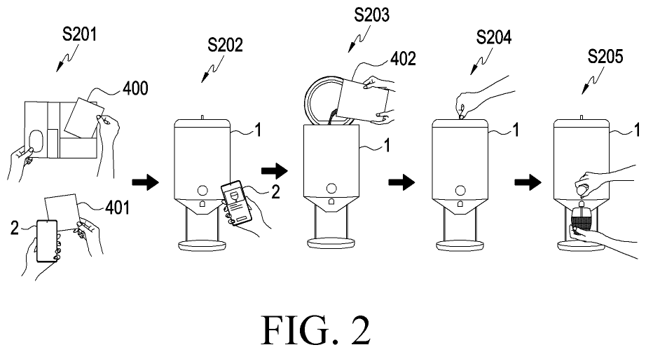

According to one or more embodiments, the control board 110 may be configured to control the operation and/or function of the producing device 1. According to one or more embodiments, the control board 110 may be configured to receive a signal from a pressure gauge disposed adjacent to a pressure gauge hole 310, control the thermostat 120 to adjust the temperature of an inner container 220, control the communication interface 130 to communicate with an external electronic device (e.g., the external electronic device 2 of FIG. 2), control the status display unit 160 to display output content, control a valve of a gas discharge port 320, or inject carbon dioxide from a carbon dioxide container connected to the carbon dioxide container connecting part 140 into the inner container 220 through a gas supply port 330. According to one or more embodiments, the control board 110 may include a processor, memory, storage and the like for operating the producing device 1.

According to one or more embodiments, the processor of the control board 110 may execute, for example, software (e.g., a program) to control at least one other component (e.g., a hardware or software component) of the fermented liquor producing device 1 coupled with the processor, and may perform various data processing or computation. According to one embodiment, as at least part of the data processing or computation, the processor may load store a command or data received from another component in volatile memory, process the command or the data stored in the volatile memory, and store resulting data in non-volatile memory or the storage.

According to one or more embodiments, the memory of the control board 110 may store various data used by at least one component (e.g., the processor or another component) of the fermented liquor producing device 1. The various data may include, for example, software (e.g., the program) and input data or output data for a command related thereto. The memory may include the volatile memory or the non-volatile memory.

According to one or more embodiments, the memory may store at least one instruction. The at least one instruction, when executed by the processor, may cause the fermented liquor producing device 1 to perform at least one operation.

According to one or more embodiments, the thermostat 120 may control the temperature inside the inner container 220 under the control of the control board 110.

According to one or more embodiments, the communication interface 130 may be configured to communicate the status of the producing device 1 with the external electronic device 2 under the control of the control board 110. According to one or more embodiments, the producing device 1 may transmit and receive a signal to and from the external electronic device 2 through the communication interface 130, and the producing device 1 may be controlled. According to one or more embodiments, the producing device 1 may be configured to control the pressure of the inner container 220, the temperature of the inner container 220, and the fermentation time according to the signal received from the external electronic device 2 through the communication interface 130.

According to one or more embodiments, the carbon dioxide container connecting part 140 may be configured to be connected to the carbon dioxide container. The carbon dioxide of the carbon dioxide container may be supplied to the inner container 220 through the carbon dioxide container connecting part 140. According to one or more embodiments, the carbon dioxide container connecting part 140 may be disposed inside the main body part 10.

According to one or more embodiments, the main body cap 150 may be configured such that at least a part thereof moves, so that at least a part of the main body part 10 may be opened or closed. According to one or more embodiments, when the main body cap 150 is opened, the carbon dioxide container connecting part 140 may be identified.

According to one or more embodiments, the status display unit 160 may display the status, function, and/or current process of the producing device 1 under the control of the control board 110. According to one or more embodiments, the status display unit 160 may include a display and/or an input unit, and the user may control the producing device 1 by inputting a signal to the producing device 1 through the input unit of the status display unit 160.

According to one or more embodiments, the container part 20 may include a fermented liquor discharge valve 201, a fermented liquor discharge port 202, a foreign body discharge port 203, a foreign body discharge valve 204, a support part 205, an outer container 210, an inner container 220, a container sealing material 230, and a container insulator 240.

According to one or more embodiments, the fermented liquor discharge valve 201 may control the amount of fermented liquor discharged to the outside of the inner container 220. When the fermented liquor discharge valve 201 is opened, the fermented liquor may be discharged to the outside through the fermented liquor discharge port 202.

According to one or more embodiments, the foreign body discharge valve 204 may control the amount of foreign body discharged from the inner container 220 to the outside. If the foreign body discharge valve 204 is opened, the foreign body may be discharged to the outside through the foreign body discharge port 203.

According to one or more embodiments, the support part 205 may serve as a support for supporting a solid or liquid discharged from the fermented liquor discharge port 202 and/or the foreign body discharge port 203 from under the fermented liquor discharge port 202 and/or the foreign body discharge port 203.

According to one or more embodiments, the outer container 210 may have a substantially cylindrical shape. The fermented liquor discharge valve 201, the fermented liquor discharge port 202, the foreign body discharge port 203, and the foreign body discharge valve 204 described above may be disposed in the outer container 210. The inner container 220 may be disposed inside the outer container 210.

According to one or more embodiments, the inner container 220 may be disposed inside the outer container 210. The temperature of the inner container 220 may be controlled by the thermostat 120 under the control of the control board 110.

According to one or more embodiments, the container insulator 240 may be disposed between the outer container 210 and the inner container 220. The container insulator 240 may be formed of a material meeting a target insulation performance, and may insulate the outside of the outer container 210 and the inside of the inner container 220.

According to one or more embodiments, the container sealing material 230 may be disposed between the outer container 210 and the inner container 220. According to one or more embodiments, the container sealing material 230 may seal the inner container 220 so that the contents of the inner container 220 are not exposed to the outside. According to one or more embodiments, the container sealing material 230 may be engaged with the container cap 30 to be described below to seal the inner container 220.

According to one or more embodiments, the container cap 30 may include a pressure gauge hole 310, a gas discharge port 320, a gas supply port 330, and a container cap sealing material 340.

According to one or more embodiments, the pressure gauge hole 310 may be formed in the container cap 30 to communicate with the inner container 220. The pressure gauge hole 310 may be configured to communicate with the pressure gauge disposed in the container cap 30. The pressure gauge and the control board 110 may be configured to exchange signals with each other.

According to one or more embodiments, the gas discharge port 320 may be formed in the container cap 30. The gas of the inner container 220 may be discharged to the outside through the gas discharge port 320. The gas discharge port 320 may be configured to be opened or closed under the control of the control board 110.

According to one or more embodiments, the gas supply port 330 may be formed in the container cap 30. The gas supply port 330 may supply carbon dioxide to the inner container 220 by passing carbon dioxide from the carbon dioxide container connected to the carbon dioxide container connecting part 140 under the control of the control board 110.

FIG. 2 illustrates a fermented liquor producing method of a fermented liquor producing device according to one or more embodiments.

The producing device 1 shown in FIG. 2 may be the same as or similar to the producing device 1 shown in FIG. 1. Therefore, a description of the same components may be omitted.

According to one or more embodiments, a recipe kit 400 may provide a recipe 401 and a fermented liquor ingredients 402. The user may identify the recipe 401 through an external electronic device 2 and may input the recipe 401 to the external electronic device 2. According to one or more embodiments, the recipe 401 may be input (S201) to the electronic device 2 through a quick response (QR) code written in the recipe 401.

According to one or more embodiments, the recipe 401 input to the external electronic device 2 may be input (e.g., S202 of FIG. 2) to the producing device 1. According to one or more embodiments, information about the recipe 401 may be input to the producing device 10 through the communication interface 130 of the producing device 10.

According to one or more embodiments, the fermented liquor ingredients 402 may be added (e.g., S203 of FIG. 2) to the producing device 1.

According to one or more embodiments, the producing device 1 may perform (S204) a fermentation process, a stabilization process, and a refrigerated aging process on the fermented liquor ingredients 402 added to the producing device 1 according to the input recipe 401.

According to one or more embodiments, the fermented liquor may be discharged from the producing device 1 (S205).

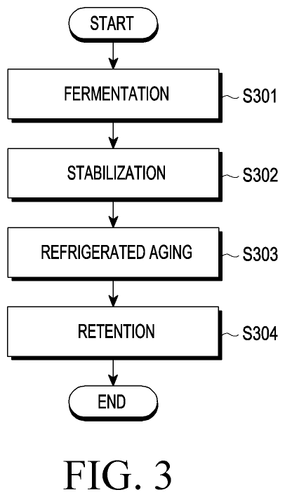

FIG. 3 illustrates a fermented liquor producing process according to one or more embodiments.

The fermented liquor producing process shown in FIG. 3 illustrates a detailed process of the fermented liquor producing process (e.g., S204 of FIG. 2) shown in FIG. 2 using the producing device 1 shown in FIG. 1. Therefore, the same description of the producing device 1 and the fermented liquor producing process S204 may be omitted.

According to one or more embodiments, the fermented liquor producing process S204 may include a fermentation process S301, a stabilization process S302, a refrigerated aging process S303, and a retention process S304.

According to one or more embodiments, in the fermentation process S301, the producing device (e.g., the producing device 1 of FIG. 1) may ferment the fermented liquor ingredients (e.g., the fermented liquor ingredients 402 of FIG. 2) put into the producing device 1. The fermented liquor ingredients 402 may include sugar and yeast. Sugar contained in the fermented liquor ingredients 402 may be decomposed into alcohol and carbon dioxide by yeast. The temperature of the inner container (e.g., the inner container 220 of FIG. 1) in the fermentation process S301 may be controlled to an appropriate temperature by the thermostat (e.g., the thermostat 120 of FIG. 1) of the producing device 1. As sugar is decomposed by yeast to generate carbon dioxide, the pressure of the inner container 220 may increase. The pressure of the inner container 220 may be measured by a pressure gauge disposed adjacent to a pressure gauge hole (e.g., the pressure gauge hole 310 of FIG. 1). A signal for the measured pressure of the inner container 220 may be transmitted to a control board (e.g., the control board 110 of FIG. 1), and may be transferred to an external electronic device (e.g., the external electronic device 2 of FIG. 2) by a communication interface (e.g., the communication interface 130 of FIG. 1). The gas may be discharged to the outside of the producing device 1 through a gas discharge port (e.g., the gas discharge port 320 of FIG. 1) according to the measured pressure of the inner container 220. Accordingly, the internal pressure of the producing device 1 in the fermentation process S301 may be maintained at about 5 psi to about 15 psi. Since the temperature and pressure of the inner container 220 vary depending on the type of fermented liquor, a different temperature and pressure may be written in a recipe (e.g., the recipe 401 of FIG. 2) for each fermented liquor.

According to one or more embodiments, in the stabilization process S302, the producing device 1 may ferment residual sugar. The producing device 1 may ferment residual sugar while maintaining the pressure of the inner container 220. Depending on the type of fermented liquor, the pressure of the inner container 220 may be maintained at about 5 psi to about 30 psi. Based on fermented liquor having no, or only a trace amount of, carbonic acid, the pressure of the inner container 220 may be maintained at 0 to about 5 psi. The producing device 1 may be configured to perform the stabilization process S302 for a time based on reaching a temperature and a pressure. After the time has elapsed, the refrigerated aging process S303 may be performed.

According to one or more embodiments, the refrigerated aging process S303 may be performed based on the time elapsing in the stabilization process S302. In the refrigerated aging process S303, the producing device 1 may reduce the activity of yeast at a low temperature. As the activity of yeast decreases, non-decomposed sugar may remain. As the activity of the yeast decreases and refrigerated aging progresses, the yeast cluster and other by-products may sink on the bottom of the inner container 220. Depending on the type of fermented liquor, the pressure of the inner container 220 may be maintained at about 5 psi to about 30 psi. Based on fermented liquor having no, or only a trace amount of, carbonic acid, the pressure of the inner container 220 may be maintained at 0 to about 5 psi. The refrigerated aging process S303 may be performed for a time based on the temperature and the pressure being reached. After the time elapses, the retention process S304 may be performed.

According to one or more embodiments, the retention process S304 may be performed based on the time elapsing in the refrigerated aging process S303. In the retention process S304, the pressure may be maintained when the temperature is reached. The temperature may vary depending on the type of fermented liquor. The pressure may be the minimum pressure for discharging the fermented liquor. Pressure may vary depending on the fermented liquor. Pressure may be maintained by the supplied carbon dioxide. In the retention process S304, the alcohol concentration may vary depending on the type of fermented liquor. According to one or more embodiments, the alcohol concentration may be about 5 degrees to about 9 degrees for lager, about 7 degrees to about 11 degrees for ale, about 13 degrees for stout, about 10 degrees for white wine, and about 15 degrees for red wine.

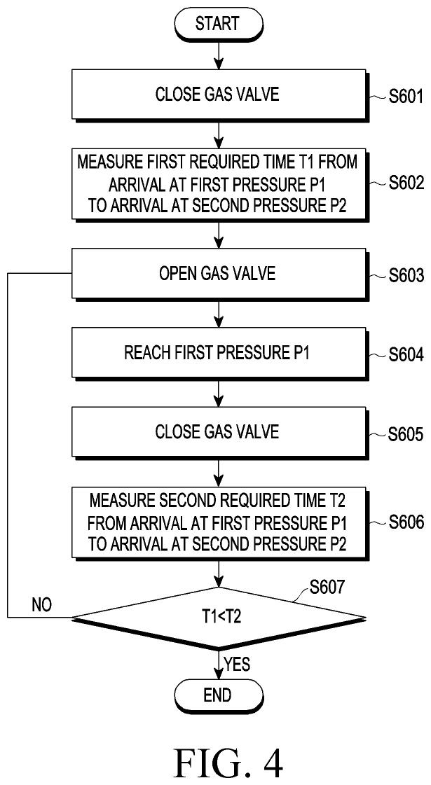

FIG. 4 illustrates a fermentation control process of a fermented liquor producing device according to one or more embodiments.

The fermentation control process illustrated in FIG. 4 is a detailed process of the fermentation process S301 illustrated in FIG. 3. Accordingly, the same description of the producing device 1, the fermented liquor producing process S204, and the fermentation process S301 may be omitted.

According to one or more embodiments, if the fermentation process S301 starts, the producing device (e.g., the producing device 1 of FIG. 1) may close the gas valve S601. According to one or more embodiments, the gas valve may be a gas discharge port (e.g., the gas discharge port 320 of FIG. 1) of the producing device 1. As the gas discharge port 320 is closed and fermentation is performed by yeast, sugar may be decomposed and alcohol and carbon dioxide may be generated. As carbon dioxide is generated and the gas valve is closed, the pressure of the inner container (e.g., the inner container 220 of FIG. 1) may increase. The pressure of the inner container 220 may reach a first pressure P1.

According to one or more embodiments, if the pressure of the inner container 220 reaches the first pressure P1, the producing device 1 may be configured to measure (S602) a first time T1 for the pressure of the inner container 220 to reach a second pressure P2, which is higher than the first pressure P1.

According to one or more embodiments, if the pressure of the inner container 220 reaches the second pressure P2, the producing device 1 may open the gas valve (S603). According to one or more embodiments, the gas valve may be the gas discharge port 320. The gas discharge port 320 may gradually discharge the gas of the inner container 220. As the gas discharge port 320 is opened, the pressure of the inner container 220 may be reduced.

According to one or more embodiments, the pressure of the inner container 220 may decrease, and thus the pressure of the inner container 220 may reach the first pressure P1 lower than the second pressure P2 (S604).

According to one or more embodiments, if the pressure of the inner container 220 reaches the first pressure P1, the producing device 1 may close the gas valve (S605). According to one or more embodiments, the gas valve may be the gas discharge port 320.

According to one or more embodiments, as the gas valve is closed after the first pressure P1 is reached and carbon dioxide is generated by fermentation, the pressure of the inner container 220 may increase. A second time T2 from when the first pressure P1 is reached to when the second pressure P2 is reached may be measured (S606).

According to one or more embodiments, the first time T1 in the process S602 and the second time T2 in the process S606 are compared, and if T1 is greater than T2, the process S603 is performed, and if T1 is smaller than T2, the fermentation control process is terminated (S607).

According to one or more embodiments, the fermentation rate may vary depending on the activity of yeast. According to one or more embodiments, as the activity of yeast increases, the rate of increase in alcohol and carbon dioxide produced increases. Conversely, as the activity of yeast decreases, the rate of increase in alcohol and carbon dioxide produced decreases. The increase or decrease in the rate of increase of carbon dioxide may be identified through the pressure gauge. Accordingly, the activity of the yeast may be identified by measuring the time from arrival at the first pressure P1 to arrival at the second pressure P2. According to one or more embodiments, the time from arrival at the first pressure P1 to arrival at the second pressure P2 may be increased when the activity of the yeast decreases, and may be decreased when the activity of the yeast increases.

According to one or more embodiments, in relation to the first time T1 measured in process S602 and the second time T2 measured in process S606, the first time T1 may be when the activity of yeast is high. Later, the second time T2 measured or repeatedly measured may be when the activity of yeast is low. Accordingly, if the value of the second time T2 measured or repeatedly measured is greater than the first time T1, the yeast activity may be estimated to be low. As such, it may be identified when the activity of yeast is the highest through the above process. If the fermentation process (e.g., the fermentation process S301 of FIG. 3) is completed by identifying when the activity of yeast is the highest, the taste and condition of the fermented liquor may be good.

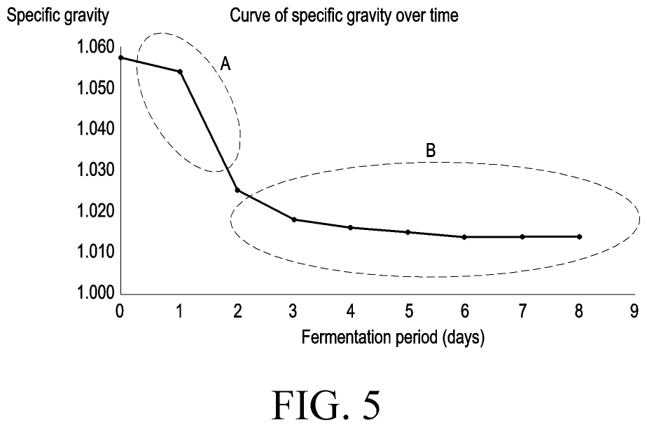

FIG. 5 illustrates the gravity of fermented liquor produced according to a fermentation period according to one or more embodiments.

FIG. 5 is a graph illustrating the gravity of fermented liquor according to the fermentation time, in which the horizontal axis denotes the fermentation period (days), and the vertical axis denotes the gravity.

According to one or more embodiments, unfermented fermented liquor ingredients (e.g., the fermented liquor ingredients 402 of FIG. 2) may include water, sugar, and yeast. As other ingredients other than water are included, the gravity of the fermented liquor ingredients 402 may be higher than 1. According to one or more embodiments, the gravity of the unfermented fermented liquor ingredients 402 may be about 1.060.

According to one or more embodiments, as fermentation of the fermented liquor ingredients 402 proceeds, sugar may be decomposed to generate alcohol and carbon dioxide. The gravity of alcohol is about 0.78, and as only a small amount of carbon dioxide is dissolved in water, the gravity of the fermented liquor ingredients 402 in the inner container (e.g., the inner container 220 of FIG. 1) may gradually decrease as fermentation progresses. When the fermentation period is 1 to 2 days, it may be identified that the gravity decreases rapidly. Referring to FIG. 5, it may be identified that the gravity of the unfermented fermented liquor ingredients 402 is about 1.060, but is reduced to about 1.055 on the first day of fermentation, to about 1.025 on the second day of fermentation, to about 1.020 on the third day of fermentation, and then converges to about 1.010.

Referring to FIG. 5, according to one or more embodiments, it may be identified that the gravity decreases rapidly on the first and second days of fermentation and the decrement in gravity reduces after the third day of fermentation. Here, the graph section of the first to second days of fermentation is referred to as section A, and the graph section after the third day of fermentation is referred to as section B.

According to one or more embodiments, the pressure of carbon dioxide may increase by 0.5 kg/cm\hat{ }2 based on the gravity of 0.001 decreasing. According to another embodiment, the pressure of carbon dioxide may increase by 2 kg/cm\hat{ }2 based on the sugar content of 1 brix decreasing.

According to one or more embodiments, the used pressure value or gravity value of carbon dioxide may vary depending on the type of fermented liquor. According to one or more embodiments, the stout or porter may use a pressure of about 1.5 kg/cm\hat{ }2 to about 2.2 kg/cm\hat{ }2, and the gravity may be reduced by about 0.0044. According to one or more embodiments, the lager and ale may use a pressure of about 2.2 kg/cm\hat{ }2 to about 2.6 kg/cm\hat{ }2, and the gravity value may be reduced by about 0.005. According to one or more embodiments, wheat beer and lambic may use a pressure of about 2.6 kg/cm\hat{ }2 to about 4.0 kg/cm\hat{ }2, and the gravity value may be reduced by about 0.006.

According to one or more embodiments, it may be identified that the activity of yeast in section A in which the gravity rapidly decreases is the highest, and it may be identified that the activity of yeast in section B in which the decrement in gravity decreases is low. As other processes are performed at the time when the activity of yeast decreases, the taste of alcohol, alcohol content, and carbonic acid may be maximized. According to one or more embodiments, the other processes may include carbonation, stabilization, and refrigerated aging processes. Depending on the type of fermented liquor, the carbonation process may not be included in the other processes.

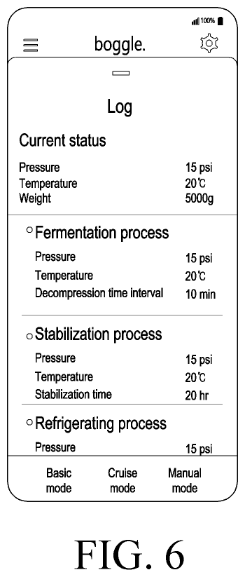

FIG. 6 illustrates a control screen controlling a fermented liquor producing device according to one or more embodiments.

FIG. 6 illustrates a control screen output by the status display unit 160 of the producing device (e.g., the producing device 1 of FIG. 1) or a control screen output by an external electronic device (e.g., the external electronic device 2 of FIG. 2).

Referring to FIG. 6, according to one or more embodiments, the control screen may be output by the producing device 1 or may be output by the external electronic device 2. According to one or more embodiments, an input to the producing device 1 may be performed through the status display unit 160 or through the external electronic device 2.

According to one or more embodiments, the control screen may output the current pressure, temperature, and weight.

According to one or more embodiments, the control screen may output pressure, temperature, and decompression time intervals in the fermentation process. The pressure, temperature, and decompression time intervals in the fermentation process may be designated by the user. According to another embodiment, they may be values input by a recipe (e.g., the recipe 401 of FIG. 2).

According to one or more embodiments, the control screen may output the pressure, temperature, and stabilization time in the stabilization process. The pressure, temperature, and decompression time intervals in the stabilization process may be designated by the user. According to another embodiment, they may be values input by the recipe 401.

According to one or more embodiments, the control screen may output the pressure, temperature, and stabilization time in the refrigerated aging process. The pressure, temperature, and decompression time intervals in the refrigerated aging process may be designated by the user. According to another embodiment, they may be values input by the recipe 401.

According to one or more embodiments, the control screen may output the pressure, the temperature, and the retention process time in the retention process. The pressure, temperature, and retention process time in the retention process may be designated by the user. According to another embodiment, they may be values input by the recipe 401.

A device (e.g., the producing device 1 of FIG. 1) for producing fermented liquor according to one or more embodiments may include a main body part (e.g., the main body part 10 of FIG. 1) including a control board (e.g., the control board 110 of FIG. 1) including a processor, a thermostat (e.g., the thermostat 120 of FIG. 1), and a communication interface (e.g., the communication interface 130 of FIG. 1) and including a carbon dioxide container connecting part (e.g., the carbon dioxide container connecting part 140 of FIG. 1), a container part (e.g., the container part 20 of FIG. 1) including an outer container (e.g., the outer container 210 of FIG. 1) in which a fermented liquor discharge valve (e.g., the fermented liquor discharge valve 201 of FIG. 1), a fermented liquor discharge port (e.g., the fermented liquor discharge port 202 of FIG. 1), a foreign body discharge valve (e.g., the foreign body discharge valve 204 of FIG. 1), and a foreign body discharge port (e.g., the foreign body discharge port 203 of FIG. 1) are formed, and an inner container (e.g., the inner container 220 of FIG. 1), and a container cap (e.g., the container cap 30 of FIG. 1) sealing the container part and including a gas discharge port (e.g., the gas discharge port 320 of FIG. 1), a gas supply port (e.g., the gas supply port 330 of FIG. 1), a pressure gauge hole (e.g., the pressure gauge hole 310 of FIG. 1), a pressure gauge, and a thermometer. The processor may be configured to perform a first process to close the gas discharge port when a pressure in the container part is a first pressure, measure a first time for the pressure in the container part measured through the pressure gauge to become a second pressure, and store the first time. The processor may be configured to perform a second process to open the gas discharge port. The processor may be configured to perform a third process to close the gas discharge port if the pressure measured through the pressure gauge becomes the first pressure and measure a second time for the pressure in the container part measured through the pressure gauge to become the second pressure. The processor may be configured to perform a fourth process configured to repeatedly perform the second process and the third process if the second time is smaller than the first time and to perform a fifth process if the second time is larger than the first time.

According to one or more embodiments, the container part may further include an inner container (e.g., the inner container 220 of FIG. 1). The inner container may be disposed inside the outer container.

According to one or more embodiments, a container insulator (e.g., the container insulator 240 of FIG. 1) may be disposed between the outer container and the inner container.

According to one or more embodiments, the container cap may further include a container cap sealing material (e.g., the container cap sealing material 340 of FIG. 1). The container part may further include a container sealing material (e.g., the container sealing material 230).

According to one or more embodiments, the main body part may further include a status display unit (e.g., the status display unit 160 of FIG. 1).

According to one or more embodiments, the status display unit may further include an input unit.

According to one or more embodiments, the processor may be configured to perform at least one process among the first process, the second process, the third process, the fourth process, and the fifth process through a signal received through the communication interface.

According to one or more embodiments, the fifth process may include at least one of a stabilization process, a refrigerated aging process, and a retention process.

According to one or more embodiments, the processor may be configured to control the thermostat such that a temperature in the container part is maintained as a designated temperature.

According to one or more embodiments, the processor may be configured to inject carbon dioxide injected from the carbon dioxide container connecting part into the container part through the gas supply port.

A method for producing fermented liquor according to one or more embodiments may use a device (e.g., the producing device 1 of FIG. 1) for producing fermented liquor according to one or more embodiments may include a main body part (e.g., the main body part 10 of FIG. 1) including a control board (e.g., the control board 110 of FIG. 1) including a processor, a thermostat (e.g., the thermostat 120 of FIG. 1), and a communication interface (e.g., the communication interface 130 of FIG. 1) and including a carbon dioxide container connecting part (e.g., the carbon dioxide container connecting part 140 of FIG. 1), a container part including an outer container (e.g., the outer container 210 of FIG. 1) in which a fermented liquor discharge valve (e.g., the fermented liquor discharge valve 201 of FIG. 1), a fermented liquor discharge port (e.g., the fermented liquor discharge port 202 of FIG. 1), a foreign body discharge valve (e.g., the foreign body discharge valve 204 of FIG. 1), and a foreign body discharge port (e.g., the foreign body discharge port 203 of FIG. 1) are formed, and a container cap (e.g., the container cap 30 of FIG. 1) sealing the container part and including a gas discharge port (e.g., the gas discharge port 320 of FIG. 1), a gas supply port (e.g., the gas supply port 330 of FIG. 1), a pressure gauge hole (e.g., the pressure gauge hole 310 of FIG. 1), a pressure gauge, and a thermometer and may include a first process to close the gas discharge port when a pressure in the container part is a first pressure, measure a first time for the pressure in the container part measured through the pressure gauge to become a second pressure, and store the first time, a second process to open the gas discharge port, a third process to close the gas discharge port if the pressure measured through the pressure gauge becomes the first pressure and measure a second time for the pressure in the container part measured through the pressure gauge to become the second pressure, and a fourth process configured to repeatedly perform the second process and the third process if the second time is smaller than the first time and to perform a fifth process if the second time is larger than the first time.

According to one or more embodiments, the container part may further include an inner container (e.g., the inner container 220 of FIG. 1). The inner container may be disposed inside the outer container.

According to one or more embodiments, a container insulator (e.g., the container insulator 240 of FIG. 1) may be disposed between the outer container and the inner container.

According to one or more embodiments, the container cap may further include a container cap sealing material (e.g., the container cap sealing material 340 of FIG. 1). The container part may further include a container sealing material (e.g., the container sealing material 230).

According to one or more embodiments, the main body part may further include a status display unit (e.g., the status display unit 160 of FIG. 1).

According to one or more embodiments, the status display unit may further include an input unit.

According to one or more embodiments, it may be configured to perform at least one process among the first process, the second process, the third process, the fourth process, and the fifth process through a signal received through the communication interface.

According to one or more embodiments, the fifth process may include at least one of a stabilization process, a refrigerated aging process, and a maintaining process.

According to one or more embodiments, the thermostat may be controlled to be such that a temperature in the container part is maintained as a designated temperature.

According to one or more embodiments, carbon dioxide injected from the carbon dioxide container connecting part may be injected into the container part through the gas supply port.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A device for producing fermented liquor, comprising:
a main body, comprising:
a control board, comprising:
a memory storing at least one instruction;
at least one processor;
a storage;
a thermostat; and
a communication interface; and
a carbon dioxide container connection; and
a container, comprising:
an outer container, comprising:
a fermented liquor discharge valve;
a fermented liquor discharge port;
a foreign body discharge valve; and
a foreign body discharge port; and
a container cap configured to seal the container, comprising:
a gas discharge port;
a gas supply port;
a pressure gauge hole;
a pressure gauge; and
a thermometer,
wherein the at least one processor is configured to execute the at least one instruction to cause the device to:
close the gas discharge port based on a pressure in the container reaching a first pressure;
measure a first time for the pressure in the container measured through the pressure gauge to become a second pressure, and store the first time in the storage;
open the gas discharge port;
close the gas discharge port based on the pressure measured through the pressure gauge becoming the first pressure;
measure a second time for the pressure in the container measured through the pressure gauge to become the second pressure; and
repeatedly, based on the second time being smaller than the first time:
open the gas discharge port;
close the gas discharge port based on the pressure measured through the pressure gauge becoming the first pressure; and
measure the second time for the pressure in the container measured through the pressure gauge to become the second pressure.

2. The device of claim 1, wherein the container further comprises an inner container, and
wherein the inner container is disposed inside the outer container.

3. The device of claim 2, wherein a container insulator is disposed between the outer container and the inner container.

4. The device of claim 1, wherein the container cap further comprises a container cap sealing material, and
wherein the container further comprises a container sealing material.

5. The device of claim 1, wherein the main body further comprises a status display.

6. The device of claim 5, wherein the status display is further configured to receive an input.

7. The device of claim 1, wherein the at least one processor is further configured to execute the at least one instruction based on a signal received through the communication interface.

8. The device of claim 7, wherein the at least one processor is further configured to execute the at least one instruction to cause the device to perform at least one of stabilization, refrigerated aging, or retention, based on the signal received through the communication interface.

9. The device of claim 1, wherein the at least one processor is further configured to execute the at least one instruction to control the thermostat such that a temperature in the container is maintained as a designated temperature.

10. The device of claim 1, wherein the at least one processor is further configured to execute the at least one instruction to cause the device to inject carbon dioxide from the carbon dioxide container connection into the container through the gas supply port.

11. A method for producing fermented liquor using a fermented liquor producing device, including: a main body, including: a control board, including: a memory storing at least one instruction, at least one processor, a storage, a thermostat, and a communication interface, and including a carbon dioxide container connection, a container, including: an outer container, including: a fermented liquor discharge valve, a fermented liquor discharge port, a foreign body discharge valve, and a foreign body discharge port, and a container cap for sealing the container, and including: a gas discharge port, a gas supply port, a pressure gauge hole, a pressure gauge, and a thermometer, the method comprising:
closing the gas discharge port based on a pressure in the container reaching a first pressure;
measuring a first time for the pressure in the container measured through the pressure gauge to become a second pressure, and storing the first time in the storage;
opening the gas discharge port;
closing the gas discharge port based on the pressure measured through the pressure gauge becoming the first pressure and measuring a second time for the pressure in the container measured through the pressure gauge to become the second pressure; and
repeatedly performing, based on the second time being smaller than the first time:
the opening the gas discharge port;
the closing the gas discharge port based on the pressure measured through the pressure gauge becoming the first pressure; and
the measuring the second time for the pressure in the container measured through the pressure gauge to become the second pressure.

12. The method of claim 11, wherein the container further includes an inner container, and wherein the inner container is disposed inside the outer container.

13. The method of claim 12, wherein a container insulator is disposed between the outer container and the inner container.

14. The method of claim 11, wherein the container cap further includes a container cap sealing material, and wherein the container further includes a container sealing material.

15. The method of claim 11, wherein the main body further includes a status display.
